(19) United States
(12) Patent Application Publication
(10) Pub. No.: US 2009/0067840 A1
(43) Pub. Date: Mar. 12, 2009

(54) Method of providing multi-staged IP filters in a point-to-multipoint environment

(76) Inventors: Marc R. Bernard, Miramar, FL (US); John A. Stock, Leesburg, VA (US); Edward J. Szczebak, JR., Frisco, TX (US); David P. Fredrickson, Annandale, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/899,994

(22) Filed: Sep. 7, 2007

(51) Int. Cl. H04J 14/00

(52) U.S. Cl. 398/67; 398/66

(57) ABSTRACT

Various service providers have different architectures to deliver Internet Protocol Television (IPTV) to their subscribers. Some service providers equipment is based on layer 2 IPTV protocol, and other equipment is based on layer 3 IPTV protocol. Within a Passive Optical Network (PON) environment, there may be multiple service providers that employ different delivery techniques to Optical Network Terminals (ONTs). Example embodiments of the invention accommodate these different delivery mechanisms by supporting layer 2 and layer 3 delivery by dynamically configuring traffic filters as a function of a layer and content of an upstream traffic request.

### BACKGROUND OF THE INVENTION

In a passive optical network (PON), optical line terminals (OLTs) using an optical wavelength and fiber optic media communicate in downstream and upstream directions with multiple optical network terminals (ONTs) or optical network units (ONUs). A common form of data transmitted in a downstream direction within a PON is Internet Protocol Television (IPTV). An IPTV system provides digital television service using Internet Protocol over a network infrastructure. Various end user devices receive and display IPTV data at customer premises, with each form of hardware being unique to its data transmission network protocol. Requests for data flow upstream from the customer premises. Downstream traffic is returned to respond to each request from a customer premises.

### SUMMARY OF THE INVENTION

A method and corresponding apparatus of providing multi-staged IP filters in a point-to-multipoint environment within a passive optical network (PON) according to an example embodiment of the invention may include delivering downstream traffic to a customer by determining a layer and content of an upstream signal (e.g., request for traffic). The example method may also include dynamically configuring downstream traffic filters as a function of the layer and content of the upstream signal to filter downstream traffic at a network node configured to support traffic flow responsive to the upstream signal. The example embodiment may further include determining, as a function of the layer and content of the upstream signal, a source port from which to access downstream traffic for delivery to a customer. The example embodiment may also include filtering the downstream traffic and delivering filtered downstream traffic to a customer.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the invention.

FIG. 1 is a network diagram of an example passive optical network (PON);

FIG. 2 is a diagram of the signal traffic associated with a Gigabit PON (GPON) Encapsulation Method (GEM) Port ID in which traffic content contains layer 2 multicast Media Access Control (MAC) addresses and layer 3 Internet Protocol (IP) multicast MAC addresses;

FIG. 3 is a diagram of an example Optical Network Terminal (ONT) within an example PON in which the ONT filters traffic in accordance with an example embodiment of the invention;

FIG. 4 is a block diagram of an example portion of an ONT in which upstream and downstream traffic pass through the ONT in accordance with an example embodiment of the invention;

FIG. 5 is a flow diagram performed in accordance with an example embodiment of the invention;

FIG. 6 is a block diagram of an example portion of an ONT in which upstream and downstream traffic pass through the ONT to be filtered as a function of a layer and content of an upstream signal in accordance with an example embodiment of the invention; and

FIG. 7 is a flow diagram performed in accordance with an example embodiment of the invention.

FIG. 8 is a flow diagram performed in accordance with another example embodiment of the invention.

### DETAILED DESCRIPTION OF THE INVENTION

A description of example embodiments of the invention follows.

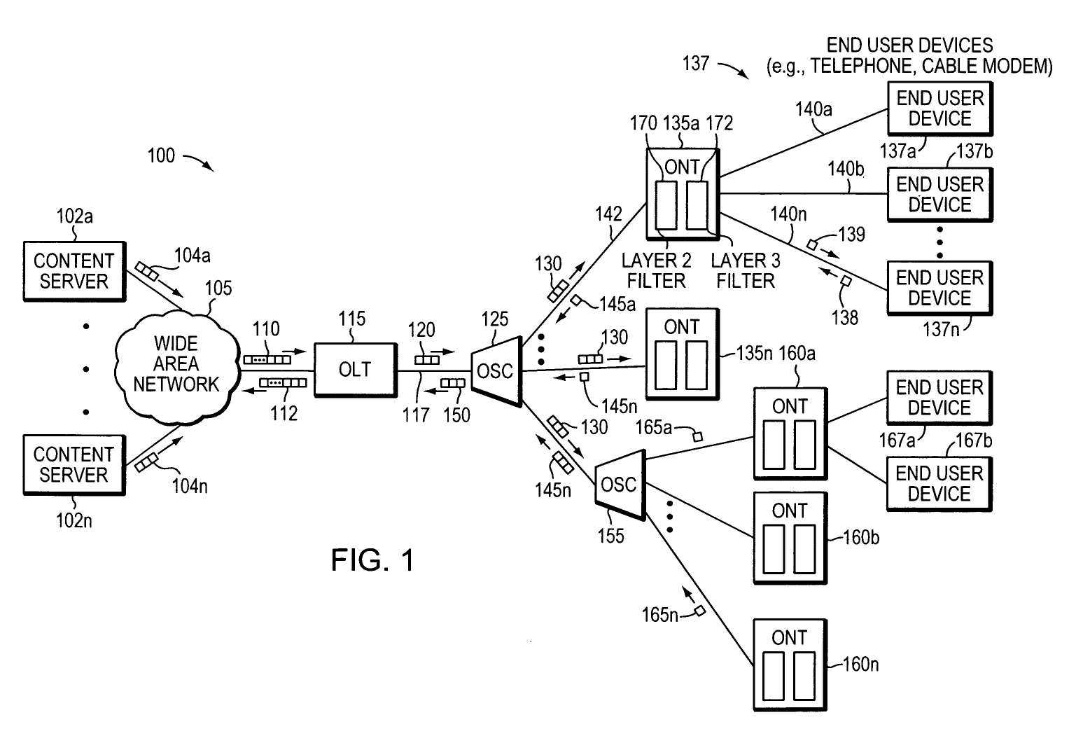

FIG. 1 is a network diagram of a passive optical network (PON) 100 illustrating aspects of an example embodiment of the invention. The PON 100 includes an optical line terminal (OLT) 115, an optical splitter/combiner (OSC) 125, and at least one optical network unit (ONT) 135a-n, 160a-n. In other network embodiments, optical network units (ONUs) (not shown) may be in optical communication with multiple ONT(s) 135a-n, 160a-n that are in electrical communication with end user equipment, such as Internet Protocol Television (IPTV) receivers, routers, telephones, home security systems, and so forth. As presented herein, ONUs are typically found at a curb, and ONT(s) extend to a premises, but both generally behave the same with respect to embodiments of this invention. Data communications 110 may be transmitted to the OLT 115 from a wide area network (WAN) 105. “Data” as used herein refers to voice, video, analog, Internet Protocol Television (IPTV), or digital data.

Communication of downstream data 120 and upstream data 150 transmitted between the OLT 115 and the ONT(s) 135a-n, 160a-n may be performed using standard communications protocols known in the art. For example, downstream data 120 may be broadcast with identification (ID) data to identify intended recipients for transmitting the downstream data 120 from the OLT 115 to the ONT(s) 135a-n. Time division multiple access (TDMA) may be used for transmitting the upstream data 150 from individual ONT(s) 135a-n, 160a-n back to the OLT 115. Note that the downstream data 120 is power divided by the OSC 125 into downstream data 130 that matches the downstream data 120 “above” the OSC 125, but with power reduced proportionally to the number of paths onto which the OSC 125 divides the downstream data 120. It should be understood that the terms “downstream data” 120, 130 and “upstream data” 150, 145a-n are optional traffic signals that typically travel via optical communications paths 117, 142, such as optical fibers.

The PON 100 may be deployed for fiber-to-the-premises (FTTP), fiber-to-the-curb (FTTC), fiber-to-the-node (FTTN), and other fiber-to-the-X (FTTX) applications. The optical fiber 117 in the PON 100 may operate at bandwidths such as 155 megabits per second (Mbps), 622 Mbps, 1.244 gigabits per second (Gbps), 2.488 Gbps, or other bandwidth implementations. The PON 100 may incorporate asynchronous transfer mode (ATM) communications, broadband services such as Ethernet access and video distribution, Ethernet point-to-multipoint topologies, native communications of data and time division multiplex (TDM) formats, or other communications suitable for a PON 100. ONT(s) 135a-n, 160a-n may receive and provide communications to and from the PON 100 and may be connected to standard telephones e.g., Public Switched Telephone Network (PSTN) and cellular telephones, Internet Protocol telephones, Ethernet units, video devices, computer terminals, digital subscriber lines, set top boxes, wireless access points, as well as any other conventional customer premises equipment 137.

The OLT 115 generates, or passes, downstream communications 120 to an OSC 125. After flowing through the OSC 125, the downstream communications 120 continue as power reduced downstream communications 130 to the ONT(s) 135a-n, where each ONT 135a-n reads data 130 intended for that particular ONT 135a-n. The power reduced downstream communications 130 may also be received by another OSC 155, where the power reduced downstream communications 130 are again power split and continue to additional ONT(s) 160a-n and/or ONUs (not shown).

Data communications 130 transmitted to an ONT 135a-n may include voice, data, video, IPTV, and/or telemetry over fiber connections, 142. The ONT(s) 135a-n transmit upstream communications signals 145a-n back to the OSC 125 via an optical link, such as the same fiber connections 142. The OSC 125, in turn, combines the ONTs 135a-n upstream signals 145a-n and transmits a combined signal 150 back to the OLT 115 employing, for example, a time division multiplexing (TDM) protocol to determine from which ONT 135a-n portions (i.e., timeslots) of the combined signal 150 are received. The OLT 115 may further transmit the communications signals 112 to a WAN 105 and content servers 102a-n or other servers (not shown).

Communications between the OLT 115 and the ONT(s) 135a-n occur using a downstream wavelength, such as 1490 nanometers (nm), and an upstream wavelength, such as 1310 nm. The downstream communications 120 broadcast from the OLT 115 to the ONT(s) 135a-n may be provided at 2.488 Gbps, which is shared across all ONT(s). The upstream communications transmitted 145a-n from the ONT(s) 135a-n to the OLT 115 may be provided at 1.244 Gbps, which is shared among all ONT(s) 135a-n connected to the OSC 125. Other communication data rates known in the art or in the future may also be employed.

In an example embodiment of the invention, a method, or corresponding apparatus, of delivering downstream traffic to a customer operates on downstream signals traveling via optical communications paths 142 to the ONT(s) 135a-n, 160a-n and upstream via the optical communications paths 140a-n from the customer premises 137 to the ONT(s) 135a-n, 160a-n. The traffic signals 138, 139 flowing along the optical communications paths may include both network protocol layer 3 traffic signals and network protocol layer 2 traffic signals. A layer 2 traffic signal (not shown) may include a unique Media Access Control (MAC) address corresponding to an end user device 137. A layer 3 traffic signal (not shown) may include multiple unique MAC addresses within a multicast group.

The embodiment may also include cascading traffic filters 170, 172 in the ONTs 135a-n, 160a-n that act upon traffic signals flowing through optical communications paths. Traffic filters 170, 172 accommodate downstream traffic signals to an end user device 137 according to determined layer and content of a signal request within the upstream traffic signal 145a-n, 165a-n. In at least one example embodiment, traffic filtering permits a customer premises to receive only the downstream traffic signals requested in the upstream traffic signal and permitted by a customer service plan.

An alternative embodiment may include filtering traffic signals within the ONT 135a responsive to end user device 137a-n requests 138. When an end user device 137a-n issues a layer 3 “join” request, a specific upstream traffic signal (e.g., containing a certain TV channel join message) is passed along the optical communications path 140a-n to the ONT 135a-n, 160a-n. By examining the layer and content of the upstream traffic signal, the ONT 135a-n, 160a-n determines which of its source ports (not shown, but corresponding to a traffic flow 104a-n corresponding to a content server 102a-n) from which to access source content. Source content travels downstream in downstream traffic signals 104a-n moving via the optical communications network 100 to the end user device(s) 137a-n. When an end user device issues a “leave” request (i.e., a network protocol layer 3 request to discontinue receiving specified signals from a source port), the request 138 is passed along the optical communications path 140a-n to the ONT 135a-n, 160a-n, and the OLT 115 or other network device discontinues sending downstream traffic signals to the end user device 137a-n, in some instances by discontinuing replication of multicast packets by the OLT 115.

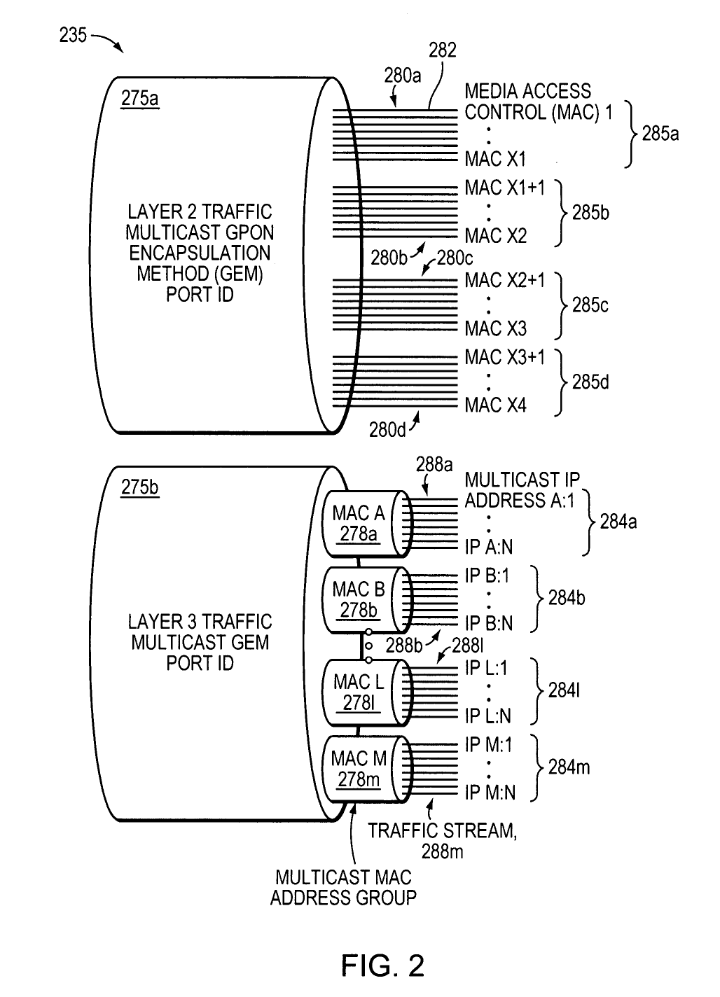

FIG. 2 is a diagram of signal traffic associated with a GPON Encapsulation Method (GEM) Port ID 275a, 275b in which signal traffic 280a-d, 288a-m contains network protocol layer 2 multicast MAC addresses 285a-d and network protocol layer 3 IP multicast MAC addresses 284a-m. Each multicast GEM Port ID 275a-b contains multicast Internet Group Management Protocol (IGMP) traffic 280a-d, 278a-m, and each of these traffic 280a-d, 278a-m contains a multicast MAC address 285a-d and a layer 3 IP multicast MAC address 284a-m.

In a network protocol layer 2 model, each multicast MAC address is associated with a single stream of traffic 282 which corresponds to a unique MAC address 285a of a target end user device (not shown). In a layer 3 model, there can be multiple multicast MAC addresses available on the PON for a given ONT. Together, the multicast MAC addresses form a logical multicast MAC address group 278a-m. For network protocol layer 3 traffic, each multicast MAC address can be associated with multiple streams of traffic.

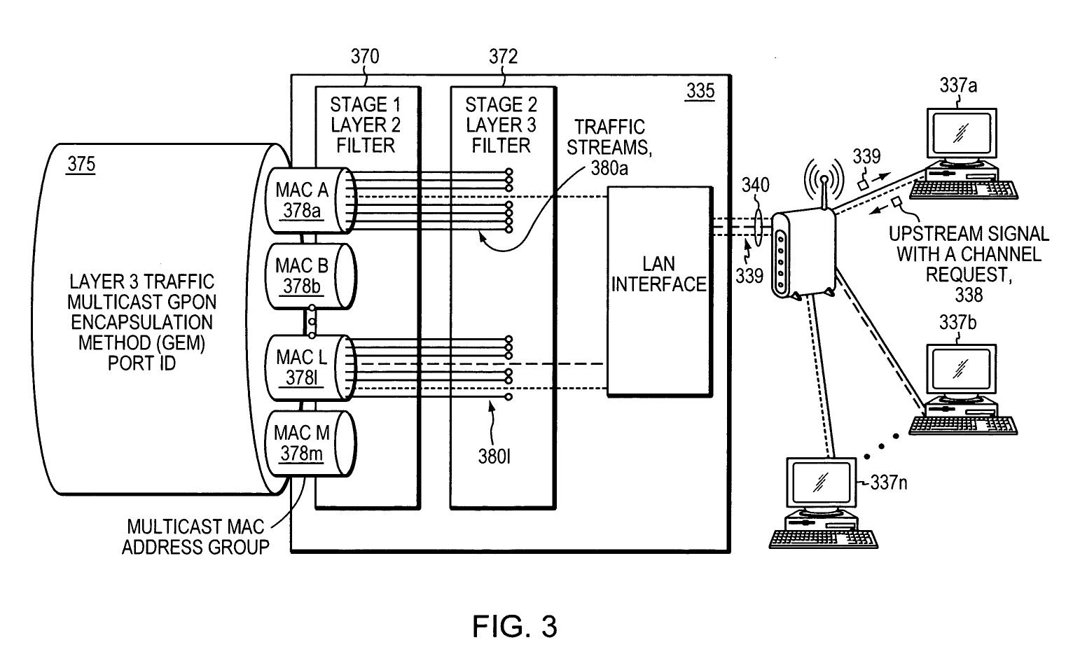

FIG. 3 is a diagram of a portion of an example ONT 235 within an example PON in which an ONT filters traffic in accordance with an example embodiment of the invention. Various service providers have different architectures to deliver IPTV to their subscribers. Some service providers' equipment is based on layer 2 IPTV protocol, and other equipment is based on layer 3 IPTV protocol. Within a PON, there may be multiple service providers that employ different delivery techniques to Optical Network Terminals (ONTs). Example embodiments of the invention accommodate these different delivery mechanisms by supporting network protocol layer 2 and layer 3 delivery by dynamically configuring traffic filters as a function of a layer and content of an upstream traffic request.

An example embodiment of the invention may be further explained by examining traffic within an ONT 335. Within an ONT 335, a multicast GEM port ID 375 encapsulates traffic into groupings to efficiently package traffic within the PON. Traffic can be further grouped into multicast MAC address groups 378a-m. Each of these multicast MAC address groups contains multiple simultaneous streams of IGMP traffic 380a, up to some maximum value N (not shown) in some embodiments. If all traffic is permitted to pass through the ONT 335 and down the optical communications path 340 to an end user device 337a-n, then the end user device 337a-n receives data incongruous to a request by the respective end user device 337a-n. Therefore, within an example embodiment of the invention, filter(s) 370, 372 are employed to examine upstream traffic 338 and permit only requested downstream traffic streams 380a-1 to continue downstream to the end user device 337a-n.

In response to an end user device request in an upstream traffic signal 338, downstream traffic 380a-1 flows through at least a stage 1 filter 370, also referred to herein as a first filtering layer 370, which examines the content and layer of the upstream signal 338 and passes downstream traffic streams 380a-1 with MAC addresses of channels in use or requested by an end user device 337a-n. If a MAC address is a unique MAC address, then this traffic 380a-1 is in its final filtered state and may continue downstream to the end user device 337a-n. Alternatively, if the MAC address remaining within the traffic signal corresponds to a multicast IP MAC address, and therefore still permits access to several streams of traffic, then at least a second level of filtering 372 occurs to block the flow of all remaining traffic except for channels being viewed (i.e., requested) by end user devices (e.g., subscribers) 337a-n. In this case, filtered traffic passes through a stage 2 filter 372, also referred to herein as a second filtering layer 372, responsive to layer 3 traffic. After multiple layers of filtering occurs, filtered traffic 339 is delivered downstream to the end user device 337a-n that made the original request 338.

A set of filters configured in a manner prescribed by the example embodiment of the invention as illustrated in FIG. 3 may not rigidly apply the same filters 370, 372 to all traffic, but, instead, dynamically configure and apply the traffic filters 370, 372 depending upon the layer and content of the traffic signal 338. At least some of the example methods and apparatus as described can remain the same even in networks in which multiple service providers support different delivery techniques to the ONTs. The example methods permit the ONT to accommodate the different delivery techniques and support both layer 2 and layer 3 traffic and corresponding filtering. Thereby, a single ONT is able to deliver layer 2 traffic to customers with layer 2 aware end user devices (not shown) and to deliver layer 3 traffic to customers with layer 3 aware end user devices 337a-n.

The filters described in the above example embodiments advantageously allow the ONT 335 to internally process channels adjacent to the channel that is being watched, allowing the ONT 335 to support better latency and faster channel change times. For example, if a user is watching channel 10, in the case where there are two filters, the stage 1 (Layer 2) filter 370 would filter channels 9, 10, and 11, and then the stage 2 (Layer 3) filter 372 would forward channel 10 to the end user devices 337a-n. Thus, if the user is simply channel surfing, and wants to scroll up or down a channel list, then the next channel will be readily available and will take less time to forward to the user, providing a better TV viewing experience. Alternatively, more than three channels may be forwarded from the stage 1 filter 370 and blocked by the stage 2 filter 372. For example, for a user watching channel 10, the stage 1 filter 370 could filter channels 8, 9, 10, 11, 12, and then the stage 2 filter 372 could forward channel 10. If the user scrolls to channel 9, then the stage 1 filter 370 could be updated to forward channels 7, 8, 9, 10, 11, and the stage 2 filter 372 could forward channel 9.

In an alternative example embodiment, the stage 1 filter 370 may continue forwarding a most recently watched video stream for a predetermined amount of time. If a user is watching a movie on channel 9, and then selects another channel during a commercial break, channel 9 will still be forwarded by the stage 1 filter 370 but will be blocked by the stage 2 filter 372 until the user goes back to channel 9. This feature could be implement using an aging timer associated with the stage 1 filter 370, whereby Channel 9 will be forwarded by the stage 1 filter 370 for a period of time (e.g., a number of seconds or minutes), assuming that the user will return to this channel. If the user does not return to this channel before the time period expires, the stage 1 filter eventually stops forwarding the channel to the stage 2 filter 372.

The above example embodiments can be combined or selectively configured by a service provider. Alternatively, there may be multiple filters that are cascaded and each filter has its own function.

In yet another example embodiment, the stage 1 filter 370 forwards a number of favorite channels, and the stage 2 filter 372 forwards channels that are being watched by the user. Alternatively, the first filter can forward channels that a user would most likely be viewing based on, for example, the time of day, day of the week, or season. This may be accomplished by allowing the ONT to learn user viewing patterns and store/update this information in memory (e.g., non-volatile memory) over time.

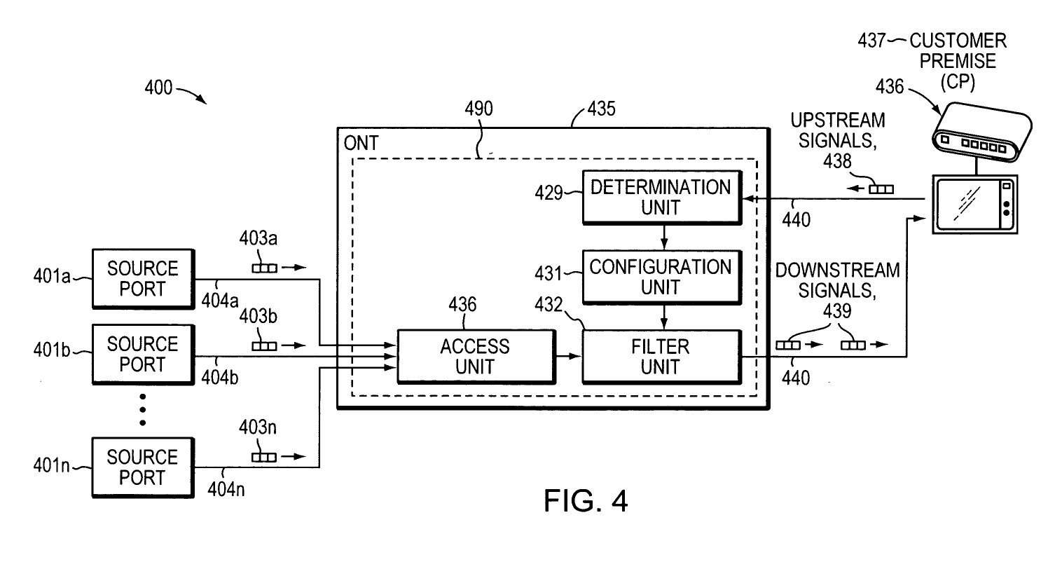

FIG. 4 is a block diagram of portions of a PON 400 illustrating in further detail example units contained within an ONT 435 according to an example embodiment of the invention. In the example illustrated in FIG. 4, the ONT 435 may include a determination unit 429, configuration unit 431, filter unit 432, and access unit 436. Initially, the ONT 435 may have access to all source ports 401a-n and permit downstream traffic 440 to flow to the end user device(s), such as an access unit 436 (and others not shown), in an customer premises 437. In response to an end user device 436 request, an upstream traffic signal 438 passes along a communications path 440 to the ONT 435. The determination unit 429 examines the layer and content contained within the upstream traffic signal 438. Utilizing the layer and content information, the configuration unit 431 dynamically configures downstream traffic filters (not shown) in the filter unit 432 so that the downstream filters can deliver downstream traffic 403a-n received by the ONT 435 according to the layer and content of the upstream traffic signal 438. The access unit 436 then determines what source port 401a-n to use to provide the requested content, again, depending on the layer and content of the request in the upstream traffic signal 438. Next, the filter unit 432 filters the requested downstream traffic 403a-n to ensure the access unit 436 is receiving only the requested content, not all the content available.

The block diagrams of FIG. 4 is merely representative and more or fewer units may be used, and operations may not necessary be divided up as described herein. Also, a processor executing software may operate to execute operations performed by the units, where a dashed line box 490 may represent a processor executing software with modules 429, 431, 432, and 436, or subset thereof as described herein. It should be understood that the block diagrams may, in practice, be implemented in hardware, firmware, or software. If implemented in software, the software may be any form capable of performing operations described herein, stored on any form of computer readable-medium, such as RAM, ROM, CD-ROM, and loaded and executed by a general purpose or application specific processor capable of performing operations described herein.

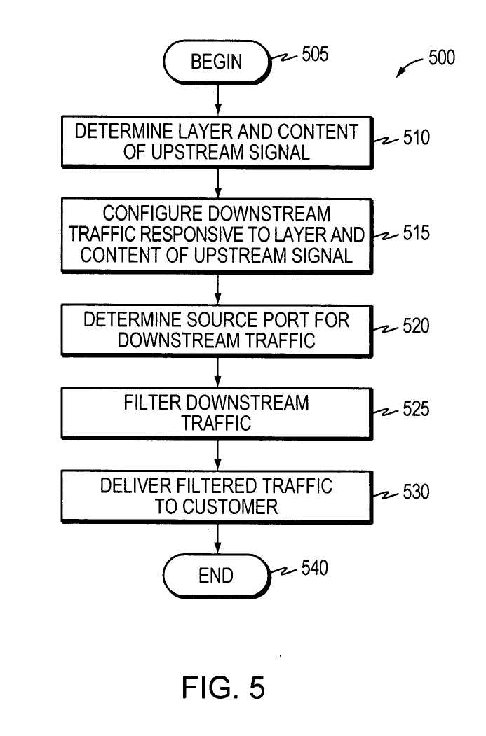

FIG. 5 illustrates, in the form of a flow diagram, an example embodiment of the invention. It should, however, be evident that various modifications and changes may be made thereto without departing from the broader spirit and scope of the invention. For example, some of the illustrated flow diagrams may be performed in an order other than that which is described. It should be appreciated that not all of the illustrated flow diagram is required to be performed, that additional flow diagram(s) may be added, and that some may be substituted with other flow diagram(s).

The example embodiment of FIG. 5 depicts a process 500 that begins (505) when an upstream traffic signal is received by the filters within an ONT. The process determines (510) a layer and content of the upstream traffic signal by examining information within the traffic signal. The upstream traffic signal is then configured (515) to respond to the layer and content of the upstream request. The process then determines (520) a source port or content server from which the downstream traffic should originate. The downstream traffic is filtered (525) to deliver traffic in a filtered state (530), which corresponds to the content request and operating layer of the end user device. The process then ends (540)

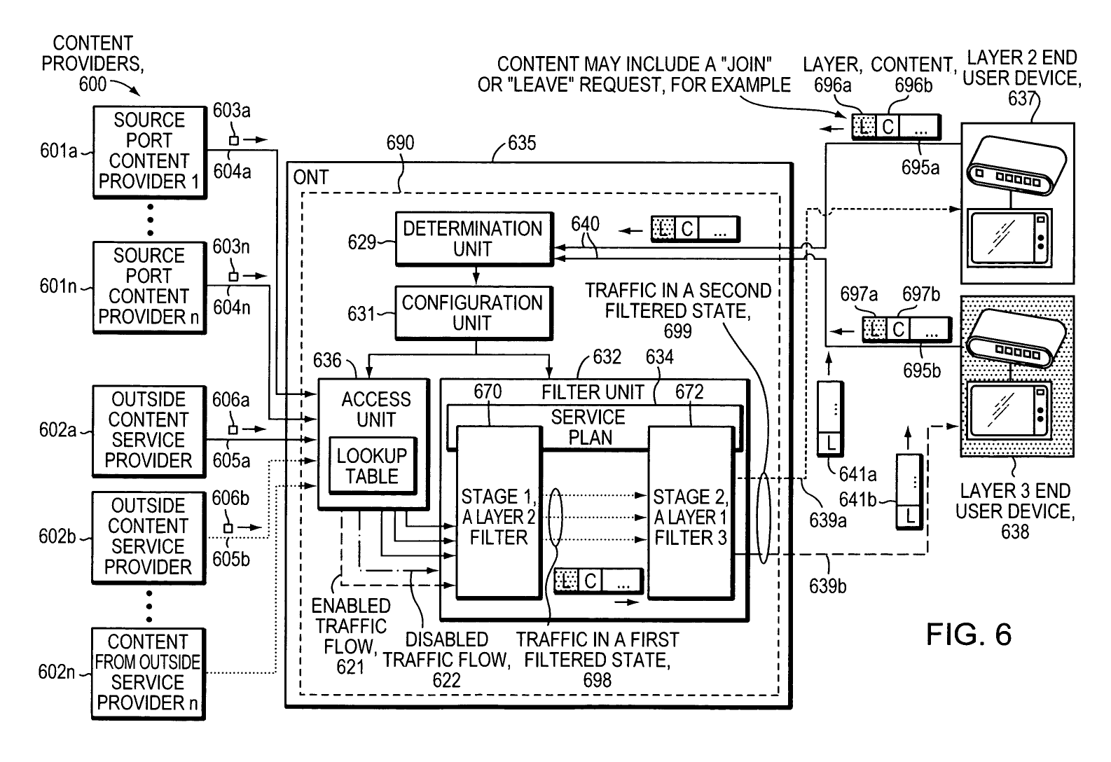

FIG. 6 is a block diagram showing portions of the PON in an example embodiment of the invention. End user devices 637, 638 at the customer premise may support network protocol layer 2 end user devices 637 or network protocol layer 3 end user devices 638. Each of these customer premises end user devices 637, 638 sends and receives signals 695a-b, 641a-b, respectively, encoded with network protocol layer 2 routing information or network protocol layer 3 routing information, depending upon the type of end user device 637, 638. Upstream traffic signal requests 695a-b (i.e., requests that travel upstream to cause network node(s) to send downstream traffic flows to the device making the requests) for content may include a layer 696a, 697a of the requesting end user device and content data 696b, 697b. According to an example embodiment of the invention, the downstream traffic signal 641a-b received in response to the upstream traffic requests 695a-b is filtered according to the layer 696a, 697a and content 696b, 697b of the upstream signal so that the content received by the end user device 637, 638 can be properly utilized by the end user device 637, 638.

In another example embodiment of the invention, after a customer makes a request for a downstream traffic stream, such as by a request to begin viewing a particular channel (e.g., a “join” request) or a request to discontinue viewing a particular channel (e.g., a “leave” request), the upstream traffic signal request 695a-b is transmitted upstream over an optical communications path 640 to an ONT 635. A determination unit 629 within the ONT 635 examines the upstream signal request 695a to determine its layer 696a and content 696b (e.g., whether the request a “join” or a “leave” and what particular channel is requested to be viewed) of the signal request 695a. Utilizing the result, a configuration unit 631 acts to configure a filter unit 632 to filter responsive to the layer 696a and content 696b of the upstream signal request 695a. An access unit 636 determines, based on the layer 696a and content 696b of the upstream signal request 695a, which source port content provider 601a provides the requested content. The access unit 636 initiates downstream traffic 603a corresponding to the request, and the filter unit 632 commences filtering the downstream traffic 603a in a manner corresponding to the request. Filtered traffic 641a flows from the filter unit 632 to the end user devices 637.

Following an example upstream traffic signal request 695a-b through the network may further explain the example embodiment of the invention illustrated in FIG. 6. For example, an end user device 638 supporting layer 3 networking protocols at the customer premises issues an upstream traffic signal request 695b to begin watching IPTV channel one. The upstream signal traffic request 695b contains at least the layer 697a (i.e., layer 3) and content 697b (i.e., “join” channel one) of the request. The upstream signal request 695b travels upstream along an optical communications path 640 to the ONT 635. Within the ONT 635, the determination unit 629 identifies the layer (in this case, layer 3) and content (i.e., “join” the programming on channel one) of the upstream traffic signal request 695b, and the configuration unit 631 configures the filters 670, 672 within the filter unit 632, accordingly.

The access unit 636 determines which networked content provider 600 provides channel one and accesses this content so downstream traffic flow along the downstream communications paths 604a-b, 605a-n. For example, assume channel one is available from source port content provider 1 601a. Downstream signal 603a travels along a communications path 604a through a wide area network (not shown), an Optical Line Terminal (OLT) (not shown), and through an Optical Splitter/Combiner (OSC) (not shown) to the ONTs, including the ONT 635, which delivers signals to the end user device 638 and receives and processes the downstream traffic signals 603a within the filter unit 632.

A stage 1 filter 670, which is a layer 2 filter, forwards only the signals with MAC addresses for channels being actively viewed upstream. For layer 3 traffic (not shown), there may be multiple IP multicast MAC addresses associated with the network layer multicast MAC address. In some embodiments, up to some number N of channels may pass through the stage 1 filter 670. Pre-filtered traffic is referred to herein as traffic in a first filtered state 698 because it has passed through at least one filter 670. This traffic 698 may contain layer 3 IP multicast MAC addresses, which correspond to several channels. A stage 2 filter 672, a layer 3 filter, further filters the traffic in a first filtered state 698 to produce traffic in a second filtered state 699 and forwards only the downstream signal 641b corresponding to the initiating upstream signal request 695b. The downstream signal 641b proceeds down the communications path 639b for receipt and viewing at the layer 3 end user device 638.

Another example embodiment of the invention may include cascading filters 670, 672 within a filter unit 632. Downstream traffic signals 603a-n, 606a-n flowing to the ONT 635 may be filtered by the series of cascading filters 670, 672 to permit only the downstream traffic signals 603a-n, 606a-n corresponding to an upstream signal request 695a-b to continue to pass downstream via the downstream communications paths 639a-b. In an example embodiment, downstream traffic signals 603a-n, 606a-n may first pass through a stage 1 (layer 2) filter 670, which filters the downstream traffic 603a-n, 606a-n to pass only specific MAC addresses for channels that are or have been actively requested by end user devices 637, 638. The traffic 698, now in a first filtered state, that passed through the stage 1 filter 670 may contain only unique MAC addresses, as supported by layer 2 traffic (not shown), or multiple Multicast IP MAC addresses (not shown), as supported by layer 3 traffic (not shown). To support the broadest of functionality, the traffic 698 in the first filtered state passes through a stage 2 (layer 3) filter 672 to produce downstream traffic signals 699 in the second filtered state. Traffic 699 in the second filtered state may contain only traffic signals which correspond to active end user device requests 695a-b.

Still another example embodiment of the invention may allow the filter unit 632 to filter downstream signal traffic 603a-n, 606a-n specific to the downstream traffic flow 603a-n, 606a-n or to filter based on the content (not shown) of the downstream traffic 603a-n, 606a-n. These techniques permit the PON in which the ONT 635 is deployed to exhibit maximum control of the flow of content within an optical communications network.

Another example embodiment may include a technique of enabling and disabling downstream traffic as shown in FIG. 6. Enabling traffic flow 621 and disabling traffic flow 622 may be useful for ONT(s) 635 with access to content (not shown) from an outside content service provider 602a. This technique allows an ONT to control external content (not shown) accessible by the end user device 637, 638. Via filtering 632, the PON (not shown) can permit traffic 603a-n, 606a-n from all, or a relatively large number (e.g., tens, hundreds, thousands) of content providers 600 to travel along downstream communications paths 604a-n, 605a-n to the customer premise 637, 638 or permit downstream traffic signals 606b from only a subset of outside content service providers 602b to travel to the end user device 638.

Another example embodiment of the invention is the a method and apparatus for filtering downstream traffic within an ONT based upon a service plan 634 associated with an end user device, or, alternatively, a customer. The dynamic configuration unit 631 can access subscription information (not shown) for a particular customer's service plan 634 and permit downstream traffic, for which the customer has a subscription, to flow downstream 639a-b. Filtering thereby prevents customer access to unauthorized data flow.

In an alternative example embodiment, a method and apparatus filters downstream traffic within an ONT based upon a scenario where a customer purchases or owns the ONT and downstream traffic is filtered to allow a selection of certain downstream signals based on the customer's ONT and service plan. The dynamic configuration unit 631 can access subscription information (not shown) for a particular customer's ONT and associated service plan 634 to permit appropriate downstream traffic to flow.

The block diagram of FIG. 6 is merely representative. More or fewer units may be used, and operations may not necessary be divided up as described herein. Also, at least one processor executing software may operate to execute operations performed by the units 629, 631, 636, 632, or combinations thereof, where a dashed line box 690 may represent an example processor. It should be understood that the block diagrams may, in practice, be implemented in hardware, firmware, or software. If implemented in software, the software may be any form capable of performing operations described herein, stored on any form of computer readable-medium, such as RAM, ROM, or CD-ROM, and loaded and executed by a general purpose or application specific processor capable of performing operations described herein.

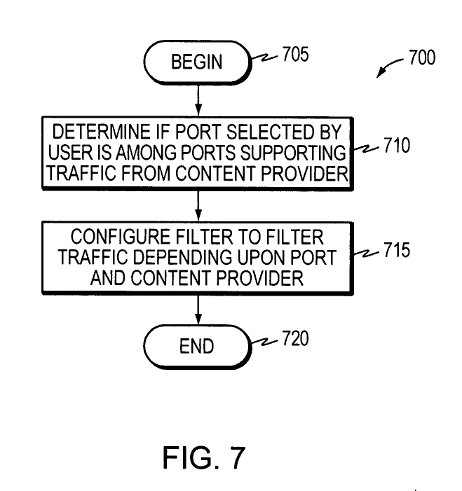

FIG. 7 illustrates, in the form of a flow diagram, an exemplary embodiment of the invention. It should, however, be evident that various modifications and changes may be made thereto without departing from the broader spirit and scope of the invention. For example, some of the illustrated flow diagrams may be performed in an order other than that which is described. It should be appreciated that not all of the illustrated flow diagram is required to be performed, that additional flow diagram(s) may be added, and that some may be substituted with other flow diagram(s).

The example embodiment of FIG. 7 depicts a process 700 that begins (705) when a request for content is initiated by an end user device. The process determines (710) if the source port selected for viewing by the end user device is among the authorized provider source ports (e.g., content providers). Traffic filters are configured (715) to enable or disable traffic flow depending upon the source port and content provider. The process 700 may end (720) or continue for further support of communications to the end user.

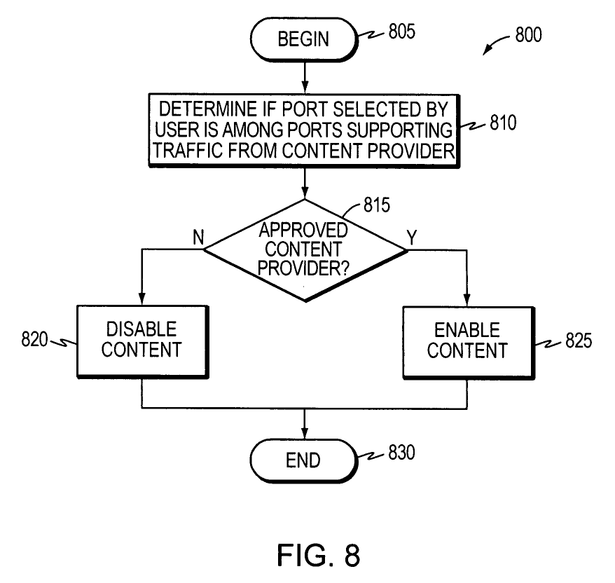

FIG. 8 is a flow diagram illustrating an example alternative embodiment of the invention. The process 800 begins (805) when a request for content is initiated by an end user device. The process determines (810) if the source port selected for viewing by the end user device is among the authorized provider source ports (e.g., content providers). The process then determines if the content provider is an approved content provider (815) (e.g., based on the content of a lookup table). If the content provider is an approved provider, the provider's content is enabled (825), and if not approved, the provider's content is disabled (820). The process 800 may end (830) or continue for further support of communications to the end user.

Alternatively, or in addition, the process may further include filtering the downstream traffic by passing the downstream traffic through a first filtering layer to produce the downstream traffic in a first filtered state. Then, based on whether the downstream traffic corresponds to a layer other than the first filtering layer, the process continues by passing the first filtered state of the downstream traffic through at least one second filtering layer to produce the downstream traffic in at least a second filtered state.

While this invention has been particularly shown and described with references to example embodiments thereof, it will be understood by those skilled in the art that various changes in form and details may be made therein without departing from the scope of the invention encompassed by the appended claims.

What is claimed is:

1. A method of delivering downstream traffic to a customer, the method comprising:
determining a layer and content of an upstream signal;
dynamically configuring downstream traffic filters as a function of the layer and content of the upstream signal to filter downstream traffic at a network node configured to support traffic flow responsive to the upstream signal;
dynamically determining, as a function of the layer and content of the upstream signal, a source port from which to access the downstream traffic; and
filtering the downstream traffic and delivering filtered downstream traffic to a customer.

2. The method according to claim 1 wherein filtering the downstream traffic includes filtering the downstream traffic in a manner automatically corresponding to the layer of the upstream traffic.

3. The method according to claim 1 wherein determining the content includes identifying a message in the upstream signal indicative of a request for new downstream traffic or indicative of a request to discontinue delivery of the downstream traffic.

4. The method according to claim 1 wherein filtering the downstream traffic includes passing the downstream traffic through a first filtering layer to produce the downstream traffic in a first filtered state, followed by passing the first filtered state of the downstream traffic through at least one second filtering layer to produce the downstream traffic in at least a second filtered state.

5. The method according to claim 4 wherein filtering the downstream traffic includes using a layer 2 networking protocol filter as the first filtering layer and using a layer 3 network protocol filter as the second filtering layer.

6. The method according to claim 1 wherein filtering the downstream traffic is specific to the downstream traffic flow.

7. The method according to claim 1 wherein filtering the downstream traffic is based on the content of the downstream traffic.

8. The method according to claim 1 wherein filtering the downstream traffic disables access to downstream traffic outside of a service provider's content or enables access to downstream traffic outside of a service provider's content.

9. The method according to claim 1 wherein filtering the downstream traffic at the network node is based on a service plan associated with the customer.

10. An apparatus for dynamically configuring traffic filters at a network node, comprising:
a determination unit to determine a layer and content of an upstream signal;
a configuration unit to configure downstream traffic filters as a function of the layer and content of the upstream signal to filter downstream traffic at a network node configured to support traffic flow responsive to the upstream signal;
an access unit to determine dynamically, as a function of the layer and content, a source port from which to access the downstream traffic; and
a filter unit to filter the downstream traffic and deliver filtered downstream traffic to a customer.

11. The apparatus as claimed in claim 10 wherein the filter unit is further configured to filter the downstream traffic in a manner automatically corresponding to the layer of the upstream traffic.

12. The apparatus as claimed in claim 10 wherein the determination unit is further configured to determine the content by identifying a message in the upstream signal indicative of a request for new downstream traffic or indicative of a request to discontinue delivery of the downstream traffic.

13. The apparatus as claimed in claim 10 wherein the filter unit is configured to pass the downstream traffic through a first filter layer to produce the downstream traffic in a first filtered state, and then to pass the downstream traffic in the first filtered state through at least one second filter layer to produce the downstream traffic in a second filtered state.

14. The apparatus as claimed in claim 13 wherein the filter unit includes a layer 2 networking protocol filter as a first filter layer and a layer 3 network protocol filter as a second filter layer.

15. The apparatus as claimed in claim 10 wherein the filter unit is configured with filters specific to the downstream traffic.

16. The apparatus as claimed in claim 10 wherein the filter unit is configured with filters based on the content of the downstream traffic.

17. The apparatus as claimed in claim 10 wherein the traffic filter is configured to disable access to downstream traffic outside of a service provider's content or to enable access to downstream traffic outside of a service provider's content.

18. The apparatus as claimed in claim 10 wherein the filter unit is configured to filter downstream traffic at the network node based on a service plan associated with the customer.

19. A computer program product comprising a computer readable medium embodying computer usable code to dynamically configure traffic filters at a network node, the computer program product including computer usable program code, which, when executed by a processor, causes the processor to:
determine a layer and content of an upstream signal;
dynamically configure downstream traffic filters to filter downstream traffic at a network node as a function of the layer and content of the upstream signal configured to support traffic flow responsive to the upstream signal;
dynamically determine, as a function of the layer and content, a source port from which to access the downstream traffic; and
filter the downstream traffic and deliver filtered downstream traffic to a customer.

20. A method of configuring traffic filters at a network node, comprising:
determining whether a port providing a channel selected for viewing by a user is among ports supporting downstream traffic from a content provider; and
dynamically configuring filters to filter at least one of multiple layers of downstream traffic as a function of the port and content provider.

21. The method according to claim 20 wherein determining whether the port supports downstream traffic from a content provider includes searching for the port or content provider in a lookup table.

22. The method according to claim 20 wherein determining whether the port supports downstream traffic from a content provider includes determining if the content provider is an approved content provider.

23. The method according to claim 22 wherein filtering the downstream traffic includes enabling content from the approved content provider and disabling content from the content provider if not approved.

24. The method according to claim 20 wherein filtering the downstream traffic includes passing the downstream traffic through a first filtering layer to produce the downstream traffic in a first filtered state, followed by, based on whether the downstream traffic corresponds to a layer other than the first filtering layer, passing the first filtered state of the downstream traffic through at least one second filtering layer to produce the downstream traffic in at least a second filtered state.

25. An apparatus for configuring traffic filters at a network node, comprising:
a determination unit configured to determine whether a port providing a channel selected for viewing by a user is among ports supporting downstream traffic from a content provider; and
a configuration unit configured to dynamically filter at least one of multiple layers of traffic as a function of the port and content provider.

26. The apparatus according to claim 25 further including a lookup table containing information about the ports and content providers and wherein the determination unit is configured to determine whether the port supports traffic from a content provider by searching for the port in the lookup table.

27. The apparatus according to claim 26 wherein the determination unit is configured to determine whether the port supports downstream traffic from a content provider by determining if the content provider is an approved content provider.

28. The apparatus according to claim 27 further including a filter unit configured to filter downstream traffic to enable content from the approved content provider and to disable content from the content provider if not approved.

29. The apparatus according to claim 25 wherein the filter unit is configured to pass the downstream traffic through a first filter layer to produce the downstream traffic in a first filtered state, and then, based on whether the downstream traffic corresponds to a layer other than the first filtering layer, pass the downstream traffic in the first filtered state through at least one second filter layer to produce the downstream traffic in a second filtered state.
